(19) United States
(12) Patent Application Publication
(10) Pub. No.: US 2023/0237124 A1
(43) Pub. Date: Jul. 27, 2023

(54) ANALYSIS APPARATUS, ANALYSIS METHOD AND PROGRAM

(71) Applicants: Nippon Telegraph and Telephone Corporation, Tokyo (JP); RIKEN, Saitama (JP)

(72) Inventors: Yuka HASHIMOTO, Musashino-shi, Tokyo (JP); Isao ISHIKAWA, Saitama (JP); Masahiro Ikeda, Saitama (JP); Yoshinobu KAWAHARA, Saitama (JP)

(21) Appl. No.: 18/015,391

(22) PCT Filed: Jul. 14, 2020
(86) PCT No.: PCT/JP2021/026531

§ 371 Date: Jan. 10, 2023

(30) Foreign Application Priority Data
Jul. 16, 2020 (JP) 2020-122352

(51) Int. Cl. G06F 17/18; G06F 7/523

(52) U.S. Cl. CPC G06F 17/18; G06F 7/523

(57) ABSTRACT

An analysis apparatus according to one embodiment includes: an obtainment unit configured to obtain a data set of multiple data items having randomness; and an analysis unit configured to calculate, as an inner product or a norm of probability measures μ and ν being probability measures on the data set and taking values in a von Neumann algebra, by using a mapping Φ that extends kernel mean embedding, an inner product or a norm of Φ(μ) and Φ(ν) mapped onto an RKHM.

### TECHNICAL FIELD

The present disclosure relates to an analysis apparatus, an analysis method, and a program.

### BACKGROUND ART

Data that appears in nature fundamentally involves randomness, and data analysis techniques that take randomness into account have been studied conventionally. As a framework for dealing with such randomness in data analysis, kernel mean embedding has been known. Randomness is formulated by a probability measure as a set function representing the likelihood of occurrences of an event. Kernel mean embedding is a method in which a concept of “proximity” such as an inner product or a norm is imparted to this probability measure, and the proximity between probability measures is determined by an inner product in a space referred to as an RKHS (reproducing kernel Hilbert space). As many data analysis methods are based on the concept of proximity, this makes it possible to apply general data analysis to data having randomness, such as measuring the proximity of data items including randomness, or estimating probability measures from which data having certain randomness is generated.

Meanwhile, as an analysis technique of data that does not include randomness and as a framework that takes interactions of multiple data items into account, a technique that uses an RKHM (reproducing kernel Hilbert Com-module) has been known. RKHM is an extension of RKHS, and instead of an inner product that normally takes a complex value, an inner product is defined to take a value in a space referred to as Com-algebra as a generalization of matrices and linear operators, with which analysis can be executed while preserving information on interactions. Accordingly, it becomes possible to precisely analyze data having interactions, and to extract information on interactions.

Meanwhile, it is often the case that data is generated by interactions of multiple random data items. Also, in the field of quantum computation or the like where a quantum is handled, the state of a quantum is represented by multiple probabilities, i.e., probabilities of observations. Although probability measures are used for formulating randomness, in the existing framework of data analysis, probability measures take complex values and cannot handle multiple randomness properties simultaneously. Meanwhile, in quantum mechanics, probability measures that take values of linear operators in a Hilbert space are used for formulating the state of a quantum represented by multiple probabilities (for example, Non-Patent Document 1). Also, in the field of pure mathematics, a concept referred to as a vector measure, which is a more generalized measure, is being studied theoretically (for example, Non-Patent Document 2).

### RELATED ART DOCUMENTS

### Non-Patent Documents

[Non-Patent Document 1] H. E. Brandt, Quantum measurement with a positive operator-valued measure. Acta Phys. Hung. B 20, 95-99, 2004.
[Non-Patent Document 2] C. W. Swartz, Products of vector measures by means of Fubini's theorem, Mathematica Slovaca, 27(4):375-382, 1977.

### SUMMARY OF THE INVENTION

### Problem to be Solved by the Invention

However, Non-Patent Document 1 and Non-Patent Document 2 described above are still in the stage of theoretical studies, and in practical data analysis, no framework using a probability measure that takes a value of a linear operator has ever existed. Recently, studies that analyze data appearing from a quantum by using machine learning techniques have also attracted attention, and from such a viewpoint, it is considered that a framework using a probability measure that takes a value of a linear operator in data analysis, and is capable of handling multiple randomness properties simultaneously, is important.

One embodiment of the present invention has been made in view of the points described above, and has an object to implement data analysis having multiple randomness properties.

### Means for Solving Problem

In order to achieve the above object, an analysis apparatus according to one embodiment includes: an obtainment unit configured to obtain a data set of multiple data items having randomness; and an analysis unit configured to calculate, as an inner product or a norm of probability measures μ and ν being probability measures on the data set and taking values in a von Neumann algebra, by using a mapping Φ that extends kernel mean embedding, an inner product or a norm of Φ(μ) and Φ(ν) mapped onto an RKHM.

### Advantageous Effects of the Invention

Data analysis with multiple randomness properties can be implemented.

### BRIEF DESCRIPTION OF THE DRAWINGS

FIG. 1 is a diagram illustrating an example of a hardware configuration of an analysis apparatus according to a present embodiment;

FIG. 2 is a diagram illustrating an example of a functional configuration of the analysis apparatus according to the present embodiment;

FIG. 3 is a flow chart illustrating an example of data analysis processing according to the present embodiment;

FIG. 4 is a diagram (part 1) illustrating an example of an experiment result; and

FIG. 5 is a diagram (part 2) illustrating an example of an experiment result.

### EMBODIMENTS FOR CARRYING OUT THE INVENTION

In the following, one embodiment of the present invention will be described. In the present embodiment, an analysis apparatus 10 that can analyze data having multiple randomness properties will be described. By using the analysis apparatus 10 according to the present embodiment, analysis of data having multiple randomness properties, in particular, for example, visualization of data in the case where multiple random data items are interacting with one another and data representing the state of a quantum, anomaly detection, and the like can be executed. Note that in addition to analysis such as visualization, anomaly detection, and the like, for example, the analysis apparatus 10 according to the present embodiment may execute control such as stopping a device, equipment, a program, or the like indicated by data in which an anomaly is detected based on the analysis result (in particular, an anomaly detection result or the like).

### <Theoretical Construction and Application Examples>

First, theoretical construction and application examples of the present embodiment will be described. In the present embodiment, kernel mean embedding is extended to impart a concept of “proximity” such as an inner product and a norm to a probability measure that takes a value of a linear operator. However, in order to execute an analysis that preserves as much information as possible on multiple randomness properties, the value of the inner product is not a complex value but a value of a linear operator. For this purpose, kernel mean embedding using an RKHM is used instead of the known kernel mean embedding using an RKHS.

### 1. Kernel Mean Embedding Using RKHM

Let X be a space to which data (data having randomness) belongs, and let A be a von Neumann algebra, to consider an A-valued positive definite kernel k:X×X→A. Here, when stating that a mapping k:X×X→A is an A-valued positive definite kernel, the mapping satisfies the following Condition 1 and Condition 2. Note that as specific examples of the von Neumann algebra, for example, a set of all linear operators, a set of all matrices, and the like may be enumerated.

(Condition 1) For any x, y∈X, k(x,y)=k(x,y)* (where * denotes conjugate).
(Condition 2) Let m be any natural number, for any x₀, x₁, . . . , xₘ₋₁∈X and any c₀, c₁, . . . , cₘ₋₁∈A, the following double summation is positive.

$$[ Math . 1 ]$$

$${\sum }_{t = 0}^{m - 1} {\sum }_{s = 0}^{m - 1} {c}_{t}^{*} k ( {x}_{t} , {x}_{s} ) {c}_{s}$$

Here, “positive” means being positive constant in the von Neumann algebra, which is a generalization of a Hermitian matrix whose all eigenvalues are greater than or equal to 0 (i.e., Hermitian positive definite), or the like.

Given an A-valued positive definite kernel k, a mapping φ from X to an A-valued function is defined by φ(x)=k(⋅,x). This mapping φ is also referred to as a feature map.

For a natural number m; x₀, x₁, . . . xₘ₋₁∈X; and c₀, c₁, . . . , cₘ₋₁∈A, a space referred to as an RKHM can be constructed from the entirety of the following linear combination.

$$[ Math . 2 ]$$

$${\sum }_{t = 0}^{m - 1} ϕ ( {x}_{t} ) {c}_{t}$$

This space is denoted as Mₖ. In Mₖ, an inner product [symbol] ⋅,⋅ [symbol] ₖ taking an A value and a magnitude |⋅|ₖ taking an A value can be defined.

An A-valued measure on X is a function μ from a subset of X referred to as a measurable set, to A, that satisfies, for a countable infinite number of measurable sets E₁, E₂, . . . where no two pair has an intersection, the following equation:

$$[ Math . 3 ]$$

$$μ ( {⋃}_{i = 1}^{∞} {E}_{i} ) = {\sum }_{i = 1}^{∞} μ ( {E}_{i} )$$

For an A-valued measure, an integral with respect to the measure can be considered. When an A-valued function f is represented as a limit of a sequence of functions referred to as simple functions as follows:

{sᵢ}ᵢ₌₁^{∞} [Math. 4]

the integral of f with respect to μ is defined as a limit of the integrals of sᵢ with respect to μ, where a simple function s is, for a certain finite number of measurable sets E₁, . . . , Eₙ in which no two pair has an intersection, and c₁, . . . , cₙ∈A, expressed as follow:

$$[ Math . 5 ]$$

$$s ( x ) = {\sum }_{i = 1}^{n} {c}_{i} {χ}_{{E}_{i}} ( x )$$

where

χ_{Ε}_{ᵢ} [Math. 6]

is an indicator function.

At this time, a value obtained by integrating s(x) with μ from the left is defined as follows:

$$[ Math . 7 ]$$

$${\sum }_{t = 1}^{n} μ ( {E}_{i} ) {c}_{t}$$

and expressed as follows:

∫_{x∈X}dμ(x)s(x) [Math. 8]

Similarly, a value obtained by integrating s(x) with μ from the right is defined as follows:

$$[ Math . 9 ]$$

$${\sum }_{t = 1}^{n} {c}_{i} μ ( {E}_{i} )$$

and expressed as follows:

∫_{x∈X}s(x)dμ(x) [Math. 10]

Under the settings described above, a mapping Φ that maps finite A-valued measures to elements in the RKHM is defined as follows:

Φ(μ)=∫_{x∈X}ϕ(x)dμ(x) [Math. 11]

which is referred to as kernel mean embedding. As the A-valued inner product between elements in the RKHM is determined, if Φ is injective, the A-valued inner product of finite A-valued measures μ and ν can be defined by the A-valued inner product of Φ(μ) and Φ(ν).

For example, for X=R^{d} and A=C^{m×m}, define k:X×X→A as follows:

k(x,y)=e^{-c∥x-y∥}^{_{Ε}}^{^{z}}I [Math. 12]

where ∥⋅∥_{Ε} is a Euclidean norm on R^{d}, c>0, and I is an identity matrix of order m. Also, R represents the entirety of real number values and C represents the entirety of complex number values. At this time, it can be shown that Φ determined from this k is injective.

### 2. Applications of Kernel Mean Embedding Using RKHM

### 2.1 Distance Between A-Valued Measures

An A-valued distance between finite A-valued measures μ and ν is defined as follows:

Υ(μ,ν)=|Φ(μ)−Φ(ν)|ₖ

At this time, if Φ is injective, for example, ∥Υ(μ,ν)∥ completely satisfies the properties of distance. In other words, if ∥ΥΥ(μ,ν)∥=∥Υ(ν,μ)∥ and ∥Υ(μ,ν)∥=0, then μ=ν; and ∥Υ(μ,ν)∥≥∥Υ(μ,λ)∥+∥Υ(λ,ν)∥ is satisfied for any finite A-valued measures μ, ν, and λ.

Two examples of finite A-valued measures are presented below.

### Example 1: Measures Representing Covariances Between Multiple Data Items Having Randomness

Let A=C^{m×m}, and consider two sets of m random variables X₁, . . . , Xₘ and Y₁, . . . , Yₘ that take values in X. Let P be a probability measure on X, and let μₓ be A-valued measures whose (i, j) element is a measure (Xᵢ, Xⱼ)*P representing the covariance of Xᵢ and Xⱼ (or A-valued measures of a centered version of the measures expressed in the following formula).

(Xᵢ,Xⱼ)_{*}P−X_{i*}P⊗X_{j*}P [Math. 13]

At this time, Υ(μₓ,μ_{y})=0 is equivalent to the covariances of random variables transformed by any bounded functions f and g being equal to each other. Therefore, by executing Kernel PCA that will be described later on such an A-valued measure, a space having a lower dimensionality can be obtained in which information on the covariances between data items is preserved.

In practice, when given data {x_{1,1}, x_{1,2}, . . . , x_{1,N}}, . . . , {x_{m,1}, x_{m,2}, . . . , x_{m,N}} obtained from X1, . . . , Xm, and data {y_{1,1}, y_{1,2}, . . . , y_{1,N}}, . . . , {y_{m,1}, y_{m,2}, . . . , y_{m,N}} obtained from Y₁, . . . , Yₘ, an (i, j) element of the inner product [symbol] Φ(μ_{X}), Φ(μ_{Y}) [symbol] ₖ of Φ(μ_{X}) and Φ(μ_{Y}) is approximated by the following formula (1):

$$[ Math . 14 ]$$

$${\sum }_{s , t = 1}^{N} {\sum }_{{l}^{′} = 1}^{m} \tilde{k} ( [ {x}_{i , s} , {x}_{l , s} ] , [ {x}_{{l}^{′} , t} , {x}_{j , t} ] ) - {\sum }_{s , {s}^{′} = 1}^{N} {\sum }_{l , {l}^{′} = 1}^{m} \tilde{k} ( [ {x}_{i , s} , {x}_{l , {s}^{′}} ] , [ {x}_{{l}^{′} , {t}^{′}} , {x}_{j , t} ] ) \qquad ( 1 )$$

Here, a case is considered in which k(x, y) is a C^{m×m}-valued positive definite kernel such that every element is a complexed-valued positive definite kernel on X² denoted as follow:

\tilde{k}(x,y) [Math. 15]

### Example 2: Measures Representing States of Quantum

In quantum mechanics, A is defined as a set of all bounded linear operators. A state of a quantum is represented by a linear operator and its observation is represented by an A-valued measure μ; therefore, with respect to linear operators ρ₁ and ρ₂ representing states of the quantum, and A-valued measures μ₁ and μ₂ representing observations, the proximity of observations pipe μ₁ρ₁ and μ₂ρ₂ of the states can be represented by the inner product of Φ(μ₁ρ₁) and Φ(μ₂ρ₂).

For example, let A=C^{m×m} and X=C^{m}, and for i=1, . . . , s, let |ψᵢ [symbol] ∈X be a normalized vector. Under these settings, consider observations (i.e., A-valued measures on X) expressed as follows:

$$[ Math . 16 ]$$

$$μ = {\sum }_{i = 1}^{s} \vert {ψ}_{i} 〉 〈 {ψ}_{i} \vert {δ}_{i}$$

At this time, for states ρ₁, ρ₂∈C^{m×m}, an inner product of Φ(μρ₁) and Φ(μρ₂) can be calculated by the following formula (2):

$$[ Math . 17 ]$$

$${\sum }_{i , j = 1}^{s} {ρ}_{1} \vert {ψ}_{i} 〉 〈 {ψ}_{i} \vert k ( \vert {ψ}_{i} 〉 , \vert {ψ}_{j} 〉 ) \vert {ψ}_{j} 〉 〈 {ψ}_{j} \vert {ρ}_{2} \qquad ( 2 )$$

### 2.2 Kernel PCA

Let A=C^{m×m}. For multiple A-valued measures μ₁, . . . , μₙ, let G be a matrix having [symbol] Φ(μᵢ), Φ(μⱼ) [symbol] ₖ∈A as (i,j) blocks. Then, G is a Hermitian positive definite matrix, and hence, there exist eigenvalues λ₁≥ . . . ≥λₘₙ≥0 and orthonormal eigenvectors v₁, . . . , vₘₙ corresponding to these eigenvalues. An i-th principal axis is defined as follows:

\sqrt{λᵢ}[Φ(μ₁), . . . ,Φ(μₙ)][vᵢ,0, . . . ,0] [Math. 18]

and is denoting as pᵢ, then, p₁, . . . , pₛ satisfy the following formula (3) with respect to any s=1, . . . , mn.

$$[ Math . 19 ]$$

$${min}_{{{p}_{j} : orthonormal}_{{〈 {p}_{j} , {p}_{j} )}_{k} : rank 1}} tr ( {\sum }_{i = 1}^{n} {\vert Φ ( {μ}_{i} ) - {\sum }_{j = 1}^{s} {p}_{j} {〈 {p}_{j} , Φ ( {μ}_{i} ) 〉}_{k} \vert}_{k} ) \qquad ( 3 )$$

In other words, p₁, . . . , pₛ can be regarded as a vector that minimizes the error among s vectors (normally s<<n) that represent Φ(μ₁), . . . , Φ(μₙ). Therefore, by approximating Φ(μᵢ) with the following formula,

$$[ Math . 20 ]$$

$${\sum }_{j = 1}^{s} {p}_{j} {〈 {p}_{j} , Φ ( {μ}_{i} ) 〉}_{k}$$

μ₁, . . . , μₙ can be visualized, or for a certain A-valued measure μ₀, by regarding the following formula,

$$[ Math . 21 ]$$

$${\vert Φ ( {μ}_{0} ) - {\sum }_{j = 1}^{s} {p}_{j} {〈 {p}_{j} , Φ ( {μ}_{0} ) 〉}_{k} \vert}_{k}$$

as a value indicating to what extent μ₀ deviates from μ₁, . . . , μₙ, anomaly detection can be executed. Also, as described above, the dimensionality reduction can be executed while preserving information on the covariances between data items.

### 2.3 Other Application Examples

Existing methods in machine learning and statistics that use kernel mean embedding in an RKHS can be applied to data having multiple elements dependent on one another, by generalizing kernel mean embedding of probability measures in the RKHS to kernel mean embedding of measures representing covariances in an RKHM as described in the above Example 1. For example, the following examples may be considered.
Reference material 1 “A. Gretton, K. M. Borgwardt, M. J. Rasch, B. Schölkopf, and A. Smola, A kernel two-sample test, Journal of Machine Learning Research, 13(1):723-773, 2012.” By generalizing two-sample test described in this material, data items having multiple elements dependent on one another can be compared.
Reference material 2 “W. Jitkrittum, P. Sangkloy, M. W. Gondal, A. Raj, J. Hays, and B. Schölkopf, Kernel mean matching for content addressability of GANs, In Proceedings of the 36th International Conference on Machine Learning, volume 97, pages 3140-3151, 2019.” By generalizing kernel mean matching for a generative model described in this material, data can be generated in which information on the covariances of multiple elements dependent on one another is preserved.
Reference material 3 “H. Li, S. J. Pan, S. Wang, and A. C. Kot, Heterogeneous domain adaptation via nonlinear matrix factorization, IEEE Transactions on Neural Networks and Learning Systems, 31:984-996, 2019.” By generalizing domain adaptation using MMD described in this material, learning can be executed while preserving information on the covariances in the case where data of a source domain and data of a target domain have multiple elements dependent on one another.

Also, by using the inner product of kernel mean embedding for measures representing the state of a quantum described in Example 2 above, the state of the quantum can be analyzed using machine learning or statistical methods.

### <Hardware Configuration of Analysis Apparatus 10>

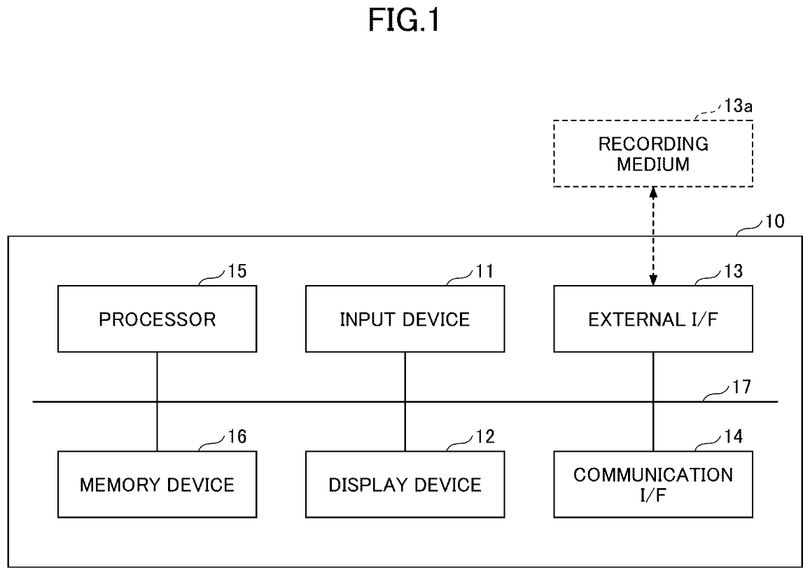

Next, a hardware configuration of the analysis apparatus 10 according to the present embodiment will be described with reference to FIG. 1. FIG. 1 is a diagram illustrating an example of a hardware configuration of the analysis apparatus 10 according to the present embodiment.

As illustrated in FIG. 1, the analysis apparatus 10 according to the present embodiment is implemented by a generic computer or computer system, and includes, as hardware components, an input device 11, a display device 12, an external I/F 13, a communication I/F 14, a processor 15, and a memory device 16. These hardware components are connected via a bus 17 so as to be capable of communicating with each other.

The input device 11 is, for example, a keyboard, a mouse, a touch panel, and the like. The display device 12 is, for example, a display or the like. Note that the analysis apparatus 10 may or may not have at least one of the input device 11 and the display device 12.

The external I/F 13 is an interface with an external device. The external device includes a recording medium 13a or the like. The analysis apparatus 10 can execute reading and writing with the recording medium 13a via the external I/F 13. Note that the recording medium 13a includes, for example, CD (Compact Disc), DVD (Digital Versatile Disk), SD memory card (Secure Digital memory card), USB (Universal Serial Bus) memory card, and the like.

The communication I/F 14 is an interface for connecting the analysis apparatus 10 to a communication network. The processor 15 includes various types of arithmetic/logic devices, for example, a CPU (Central Processing Unit), a GPU (Graphics Processing Unit), and the like. The memory device 16 is various types of storage devices such as, for example, an HDD (Hard Disk Drive), SSD (Solid State Drive), RAM (Random Access Memory), ROM (Read-Only Memory), flash memory, or the like.

By having the hardware configuration illustrated in FIG. 1, the analysis apparatus 10 according to the present embodiment can implement data analysis processing as will be described later. Note that the hardware configuration illustrated in FIG. 1 is an example, and the analysis apparatus 10 may have another hardware configuration. For example, the analysis apparatus 10 may have multiple processors 15 or multiple memory devices 16.

### <Functional Configuration of Analysis Apparatus 10>

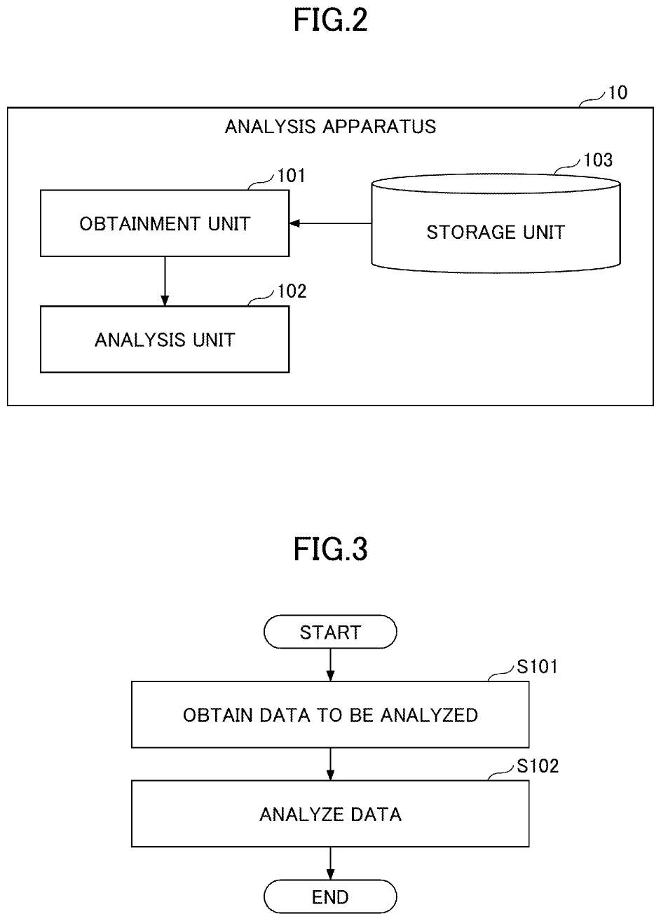

Next, a functional configuration of the analysis apparatus 10 according to the present embodiment will be described with reference to FIG. 2. FIG. 2 is a diagram illustrating an example of a functional configuration of the analysis apparatus 10 according to the present embodiment.

As illustrated in FIG. 2, the analysis apparatus 10 according to the present embodiment includes, as functional units, an obtainment unit 101, an analysis unit 102, and a storage unit 103. The obtainment unit 101 and the analysis unit 102 are implemented by, for example, a process in which one or more programs installed in the analysis apparatus 10 causes the processor 15 to execute. Also, the storage unit 103 can be implemented by using, for example, the memory device 16. However, the storage unit 103 may be implemented by, for example, a storage device connected to the analysis apparatus 10 through a communication network (e.g., a database server, etc.).

The storage unit 103 stores data to be analyzed (e.g., elements in X to be analyzed and A-valued measures of these, and further, linear operators representing the state of a quantum in the case of applying to Example 2 described above).

The obtainment unit 101 obtains data to be analyzed from the storage unit 103. The analysis unit 102 analyzes data obtained by the obtainment unit 101 (i.e., for example, calculation of the inner product and the norm, and visualization and anomaly detection using the calculation results, and the like).

### <Data Analysis Process>

Next, a flow of data analysis processing executed by the analysis apparatus 10 according to the present embodiment will be described with reference to FIG. 3. FIG. 3 is a flow chart illustrating an example of a data analysis process according to the present embodiment.

First, the obtainment unit 101 obtains data to be analyzed (i.e., elements in X to be analyzed and A-valued measures of these; linear operators representing states of a quantum in the case of applying to Example 2 described above; and the like) from the storage unit 103 (Step S101).

Then, the analysis unit 102 analyzes the date obtained at Step S101 described above (Step S102). Note that as examples of data analysis, calculation of the inner product and the norm described in “2. Applications of kernel mean embedding using RKHM”, visualization and anomaly detection using the calculation results, comparison of data items with one another, data generation, learning, and the like may be enumerated. Note that specific examples of methods of calculating the inner product are as expressed in the above formula (1) in the case of a measure representing the covariances between multiple data items having randomness, and as expressed in the above formula (2) in the case of measures representing the state of a quantum.

As described above, the analysis apparatus 10 according to the present embodiment can execute analysis of data having multiple randomness properties (in particular, visualization of data in the case where multiple random data items are interacting and data representing the state of a quantum, anomaly detection, and the like).

### <Experiments>

Finally, experimental results in the case where the analysis apparatus 10 according to the present embodiment was applied to Example 1 and Example 2 described in “2.1 Distance between A-valued measures” will be described.

### 1. Measures Representing Covariances Between Multiple Data Items Having Randomness;

With settings of X=R and Ω=R⁵, from random variables on Ω expressed as in the following formulas (4) to (6) that take value in X, data was generated.

[Math. 22]

X₁(ω)=ω₁, X₂(ω)=ω₂, X₃(ω)=ω₃ (4)

Y₁(ω)=ω₄ cos(0.1ω₄), Y₂(ω)=e^{ω4}, Y₃(ω)=\sqrt{|ω_{S}|} (5)

Z₁(ω)=e^{ω}^{₄}, Z₂(ω)=ω₄ cos(0.1ω₄), Z₃(ω)=\sqrt{|ω_{S}|} (6)

Let μₓ be A-valued measures such that each (i, j) element represents a covariance of Xᵢ and Xⱼ expressed as follows:

(Xᵢ,Xⱼ)_{*}P−X_{i*}P⊗X_{j*}P [Math. 23]

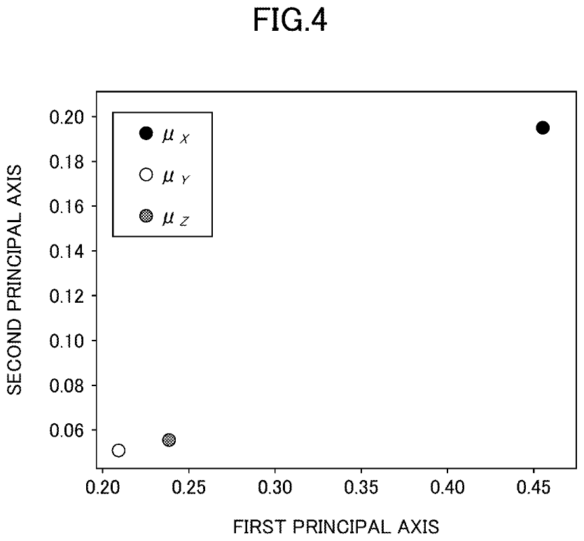

At this time, each of the inner product of Φ(μ_{X}) and Φ(μ_{Y}), the inner product of Φ(μ_{Y}) and Φ(μ_{Z}), and the inner product of Φ(μ_{X}) and Φ(μ_{Z}) was calculated by the above formula (1), and μ_{X}, μ_{Y}, and μ_{Z} were visualized with the first principal axis and the second principal axis by Kernel PCA. The result is illustrated in FIG. 4. As illustrated in FIG. 4, the distance between μ_{Y} and μ_{Z} that are related to each other is short, whereas the distance between μ_{X} and μ_{Y}, and the distance between μ_{X} and μ_{Z} that have no relationship are long.
(Comparison with Existing Method)

Independent data items according to [X₁, X₂, X₃] defined by the above formula (4), and independent data items according to [Y₁, Y₂, Y₃] defined by the above formula (5) were prepared, and the two-sample test described in the above Reference material 1 was executed. Note that the two-sample test is a test that determines whether two types of samples follow the same probability distribution.

Comparison was made between a result of executing the two-sample test applied to distances between data items (i.e., measured by |Φ(μ_{X})−Φ(μ_{Y})|ₖ) measured by the analysis apparatus 10 according to the present embodiment (the proposed method), and a result of executing the two-sample test applied to conventionally measured distances (a conventional method). As the conventional methods, an RKHS described in Reference material 1, and Kantrovich and Dadley described in Reference material 4 “B. K. Sriperumbudur, K. Fukumizu, A. Gretton, B. Schölkopf, and G. R. G. Lanckriet, On the empirical estimation of integral probability metrics. Electronic Journal of Statistics, 6:1550-1599, 2012”, were adopted. Also, in each of the following Case 1 and Case 2, tests were executed 50 times with different data sets for each of the proposed method and the conventional methods, and the rate of results in which the two types of samples were determined to follow the same distribution was calculated. The results are illustrated in Table 1 below.

Case 1: 10 independent data items according to [X₁, X₂, X₃] and 10 independent data items according to [X₁, X₂, X₃]

Case 2: 10 independent data items according to [X₁, X₂, X₃] and 10 independent data items according to [Y₁, Y₂, Y₃]

TABLE 1

| | Proposed method | RKHS | Kantrovich | Dadley |
|---|---|---|---|---|
| Case 1 | 0.94 | 0.74 | 0.88 | 0.98 |
| Case 2 | 0.06 | 0.02 | 0.06 | 0.26 |

It can be stated that the determination problem is accurately solved when the rate at which the two types of samples are determined to follow the same distribution is high in Case 1, and the rate at which the two types of samples are determined to follow the same distribution is low in Case 2. In the proposed method, a high rate of Case 1 and a low rate of Case 2 were achieved simultaneously, and it can be stated that accurate determination could be made in both cases.

### 2. Measures Representing States of Quantum

In Example 2 above, assume that m=2 and s=4. In addition, assume the following ranges:

$$[ Math . 24 ]$$

$$\vert {ψ}_{1} 〉 = [ 1 , 0 ] ,$$

$$\vert {ψ}_{2} 〉 = [ \frac{1}{\sqrt{3}} , \frac{2}{\sqrt{3}} ] ,$$

$$\vert {ψ}_{2} 〉 = [ \frac{1}{\sqrt{3}} , \frac{2}{\sqrt{3}} {e}^{\frac{2 π \sqrt{- 1}}{3}} ] ,$$

$$\vert {ψ}_{3} 〉 = [ \frac{1}{\sqrt{3}} , \frac{2}{\sqrt{3}} {e}^{\frac{4 π \sqrt{- 1}}{3}} ]$$

At this time, for a_{1,i}=0.25 (where i=1, 2, 3, 4), set ρ₁ as follows:

$$[ Math . 25 ]$$

$${ρ}_{1} = {\sum }_{i = 1}^{4} {a}_{1 , i} \vert {ψ}_{i} 〉 〈 {ψ}_{i} \vert$$

Also, for a_{2,1}=0.4, a_{2,4}=0.1, a_{2,2}=a_{2,3}=0.25, set ρ₂ as follows:

$$[ Math . 26 ]$$

$${ρ}_{2} = {\sum }_{i = 1}^{4} {a}_{2 , i} \vert {ψ}_{i} 〉 〈 {ψ}_{i} \vert$$

Further, μ is defined as in Example 2 described above. A small amount of noise was added to each of ρ₁ and ρ₂, and 50 samples were prepared for each.

At this time, a first principal axis p₁ was determined to minimize the error (reconstruction error) expressed in the above formula (3) for each of the 50 samples ρ_{1,i} (where i=1, . . . , 50) related to ρ₁, and for each of the 50 samples ρ_{j,i} (where j=1, 2 and i=1, . . . , 50) related to ρ₂, a C^{m×m}-valued reconstruction error was calculated as follows:

|Φ(ρ_{j,i}μ)−p₁ [symbol] p₁,Φ(ρ_{j,i}μ) [symbol] ₖ|ₖ [Math. 27]

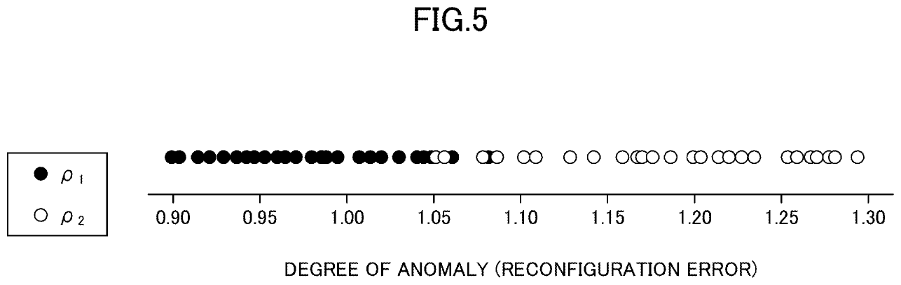

Then, values of the norms were plotted. The plotted results are illustrated in FIG. 5. In other words, in FIG. 5, The data related to ρ₁ is considered as the normal state, learning is executed using it, and a value indicating to what extent the obtained approximate p₁ [symbol] p₁,Φ(ρ_{j,i}μ) [symbol] ₖ is away from the true state Φ(ρ_{j,i}μ) is regarded as a deviation from the normal state (degree of anomaly) and plotted.

As illustrated in FIG. 5, as the degree of anomaly of the sample related to ρ₂ is higher than that of the sample related to ρ₁, it can be stated that ρ₂ deviating from ρ₁ as the normal state (i.e., an anomalous state) is shown precisely.

The present invention is not limited to the embodiments described above that have been specifically disclosed, and various modifications, changes, combinations with known techniques, and the like can be made within a scope not deviating from the description of the claims.

The present application is based on a base application No. 2020-122352 in Japan, filed on Jul. 16, 2020, the entire contents of which are hereby incorporated by reference.

### LIST OF REFERENCE NUMERALS

10 analysis apparatus
11 input device
12 display device
13 external I/F
13a recording medium
14 communication I/F
15 processor
16 memory device
17 bus
101 obtainment unit
102 analysis unit
103 storage unit

1. An analysis apparatus comprising:
a memory; and
a processor configured to execute
obtaining a data set of multiple data items having randomness; and
calculating, as an inner product or a norm of probability measures μ and ν being probability measures on the data set and taking values in a von Neumann algebra, by using a mapping Φ that extends kernel mean embedding, an inner product or a norm of φ(μ) and φ(ν) mapped onto an RKHM.

2. The analysis apparatus as claimed in claim 1, wherein the probability measures constitute a matrix having a measure representing a covariance between the multiple data items having randomness as each element, and the von Neumann algebra is a set of all complex-valued m×m matrices, and
wherein the calculating calculates, when denoting two sets of m random variables that take values on the data set as X₁, . . . , Xₘ and Y₁, . . . , Yₘ, respectively; regarding probability measures whose (i, j) element being a measure representing a measure representing a covariance of Xᵢ and Xⱼ, as μ=μ_{X}; and regarding probability measures whose (i, j) element being a measure representing a measure representing a covariance of Yᵢ and Yⱼ, as ν=μ_{Y}, by using data obtained from the random variables X₁, . . . , Xₘ and data obtained from the random variables Y₁, . . . , Yₘ, an inner product of Φ(μ_{X}) and Φ(μ_{Y}) by a positive-definite kernel that takes a value of an m×m complex-valued matrix.

3. The analysis apparatus as claimed in claim 1, wherein the probability measures are measures representing states of a quantum in quantum mechanics, and the von Neumann algebra is a set of all complex-valued m×m matrices, and
wherein the calculating calculates, when denoting measures on the von Neumann algebra representing observations of the quantum as μ′; denoting the states of the quantum as ρ₁ and ρ₂; and regarding the probability measures as μ=ρ₁μ′ and ν=ρ₂μ′, by using data included in the data set, an inner product of Φ(ρ₁μ′) and Φ(ρ₂μ′) by a positive-definite kernel that takes a value of an m×m complex-valued matrix.

4. The analysis apparatus as claimed in claim 1, wherein the calculating executes dimensionality reduction of the data set, visualization of the probability measures, or anomaly detection with respect to the probability measures, by using a calculation result of the inner product or the norm.

5. An analysis method executed by a computer including a memory and a processor, the analysis method comprising:
obtaining a data set of multiple data items having randomness; and
calculating, as an inner product or a norm of probability measures μ and ν being probability measures on the data set and taking values in a von Neumann algebra, by using a mapping Φ that extends kernel mean embedding, an inner product or a norm of Φ(μ) and Φ(ν) mapped onto an RKHM.

6. A non-transitory computer-readable recording medium having computer-readable instructions stored thereon, which when executed, cause a computer to function as the analysis apparatus as claimed in claim 1.
